(19) United States
(12) Patent Application Publication
(10) Pub. No.: US 2025/0192334 A1
(43) Pub. Date: Jun. 12, 2025

(54) ENERGY STORAGE APPARATUS

(71) Applicant: GS Yuasa International Ltd., Kyoto-shi (JP)

(72) Inventors: Koki MAEDA, Kyoto-shi (JP); Yasunori OKUNO, Kyoto-shi (JP); Yasuyuki IWASHIMA, Kyoto-shi (JP)

(21) Appl. No.: 19/058,308

(22) Filed: Feb. 20, 2025

Related U.S. Application Data
(63) Continuation of application No. PCT/JP2023/030229, filed on Aug. 23, 2023.

(30) Foreign Application Priority Data
Aug. 24, 2022 (JP) 2022-133487

(51) Int. Cl. H01M 50/291; H01G 11/10; H01G 11/78; H01M 10/0525; H01M 50/209; H01M 50/271; H01M 50/507

(52) U.S. Cl. CPC H01M 50/291; H01M 10/0525; H01M 50/209; H01M 50/271; H01M 50/507; H01G 11/10; H01G 11/78

(57) ABSTRACT

An energy storage apparatus includes an energy storage, and first, second, and third members positioned in a first direction relative to the energy storage and aligned in the first direction. The second member is between the first and third members, at least one of the first or second member includes a first rib protruding towards the other of the first or second member in a second direction intersecting the first direction, the first rib being in contact with the other of the first or second member in the second direction, and at least one of the second or third member includes a second rib protruding towards the other of the second or third member in the second direction or in a third direction intersecting the first and second directions, the second rib being in contact with the other of the second or third member in the second or third direction.

### CROSS REFERENCE TO RELATED APPLICATIONS

This application claims the benefit of priority to Japanese Patent Application No. 2022-133487 filed on Aug. 24, 2022 and is a Continuation Application of PCT Application No. PCT/JP2023/030229 filed on Aug. 23, 2023. The entire contents of each application are hereby incorporated herein by reference.

### BACKGROUND OF THE INVENTION

### 1. Field of the Invention

The present invention relates to energy storage apparatuses.

### 2. Description of the Related Art

JP 2019-519886 A discloses a battery module including a cover assembly which includes three members (inner frame, intermediate frame, and outer cover) aligned together with electrochemical cells. In the cover assembly of JP 2019-519886 A, the intermediate frame is snap fit to an outer surface of the inner frame, and the outer cover is snap fit to an outer surface of the intermediate frame.

### SUMMARY OF THE INVENTION

In a battery module in which three members are aligned together with the electrochemical cells, the three members respectively have dimensional variations, and therefore positioning among the three members is difficult in some cases. In the battery module disclosed in JP 2019-519886 A, the dimensional variations in the up-down direction of the three members included in the cover assembly may be absorbed by snap fitting. However, the dimensional variations thereof in the horizontal direction might not be absorbed in some cases. In this way, in the above-described conventional battery module, the dimensional variation of the three members aligned together with the electrochemical cells cannot be absorbed, making it difficult to position the three members in some cases.

Example embodiments of the present invention provide energy storage apparatuses that can each easily position the three members aligned together with the energy storage devices.

An energy storage apparatus includes an energy storage device, and a first member, a second member, and a third member which are positioned in a first direction of the energy storage devices and are aligned in the first direction, the second member is between the first member and the third member, at least one of the first member or the second member includes a first rib protruding towards the other of the first member or the second member in a second direction intersecting the first direction, the first rib being in contact with the other of the first member or the second member in the second direction, and at least one of the second member or the third member includes a second rib protruding towards the other of the second member or the third member either in the second direction or in a third direction intersecting the first direction and the second direction, the second rib being in contact with the other of the second member or the third member either in the second direction or the third direction.

Energy storage apparatuses according to example embodiments of the present invention can easily position the three members aligned together with the energy storage devices.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an outer appearance of an energy storage apparatus according to an example embodiment of the present invention.

FIG. 2 is an exploded perspective view illustrating respective structural elements when the energy storage apparatus according to an example embodiment of the present invention is exploded.

FIG. 3 is a perspective view illustrating a configuration of an energy storage device according to an example embodiment of the present invention.

FIGS. 4A to 4C are perspective views and a sectional view illustrating a configuration of a bus bar cover according to an example embodiment of the present invention.

FIG. 5 is a perspective view illustrating a positional relationship between a bus bar cover, a lid, and a bus bar holder according to an example embodiment of the present invention.

FIG. 6 is a sectional view illustrating a positional relationship between the bus bar cover, the lid, and the bus bar holder according to an example embodiment of the present invention.

### DETAILED DESCRIPTION OF THE EXAMPLE EMBODIMENTS

(1) An energy storage apparatus according to an example embodiment of the present invention includes an energy storage device, and a first member, a second member, and a third member which are positioned in a first direction with respect to the energy storage device and are aligned in the first direction, the second member is between the first member and the third member, at least one of the first member or the second member includes a first rib protruding towards the other of the first member or the second member in a second direction intersecting the first direction, the first rib being in contact with the other of the first member or the second member in the second direction, and at least one of the second member or the third member includes a second rib protruding towards the other of the second member or the third member in the second direction or in a third direction intersecting the first direction and the second direction, the second rib being in contact with the other of the second member or the third member in the second direction or the third direction.

According to an energy storage apparatus according to an example embodiment of the present invention, in the energy storage apparatus, the first member, the second member, and the third member are aligned in the first direction, together with the energy storage device. At least one of the first member of the second member includes a first rib in contact with the other of the first member or the second member in a second direction, and at least one of the second member or the third member includes a second rib in contact with the other of the second member or the third member in the second direction or the third direction. In this way, the first member and the second member are in contact with each other in the second direction via the first rib, thus absorbing any dimensional variation in the second direction between the first member and the second member. The second member and the third member are in contact with each other via the second rib in the second direction or the third direction, thus absorbing any dimensional variation in the second direction or the third direction between the second member and the third member. Accordingly, dimensional variations of the three members (the first member, the second member, and the third member) aligning together with the energy storage device can be absorbed with a simple configuration, and therefore, the three members can be easily positioned.

(2) In the energy storage apparatus according to the above item (1), the at least one of the first member or the second member may include two first ribs, including the first rib, interposing the other of the first member or the second member in the second direction.

According to the energy storage apparatus according to the above item (2), in the first member and the second member, the two first ribs of the one of the first member or the second member interpose the other in the second direction, thus absorbing the dimensional variations in both sides of the second direction between the first member and the second member.

(3) In the energy storage apparatus according to the above item (1) or (2), the first rib and the second rib may overlap each other when viewed from the first direction.

According to the energy storage apparatus according to the above item (3), since the first rib and the second rib overlap each other when viewed from the first direction, a force can be applied to the vicinity of the first rib and the second rib by pushing the first member and the third member relative to the second member at the overlapping positions from the first direction. Accordingly, the first rib of one of the first member or the second member can be easily brought into contact with the other, and the second rib of one of the second member or the third member can be easily brought into contact with the other.

(4) In the energy storage apparatus according to any one of the above items (1) to (3), a configuration may be possible in which the second member includes the first rib and the second rib, and rigidity of the second member is lower than rigidity of the first member and rigidity of the third member.

According to the energy storage apparatus according to the above item (4), since rigidity of the second member including the first rib and the second rib is lower than rigidity of the first member and rigidity of the third member, the first rib and the second rib are crushed when the first rib and the second rib contact the first member and the third member. Accordingly, dimensional variations of the three members (the first member, the second member, and the third member) can be absorbed with a simple configuration.

(5) In the energy storage apparatus according to any one of the above items (1) to (4), the first member may be either a bus bar holder which holds a bus bar, or a case which accommodates the energy storage device.

According to the energy storage apparatus according to the above item (5), since the first member is either a bus bar holder or a case, when placing the bus bar holder or the case with respect to the energy storage devices, dimensional variations of the bus bar holder or the case can be absorbed.

The following describes energy storage apparatuses according to example embodiments and modifications or combinations thereof, with reference to the drawings. The example embodiments described below each demonstrate either a comprehensive or a specific example. A numerical value, a shape, a material, a structural element, a position and coupling configuration of the structural elements, manufacturing processes, an order of manufacturing processes, and the like, which will be described in the following example embodiments, are merely examples, and are not intended to limit the present invention. In the drawings, dimensions, and the like, are not strictly illustrated. In the drawings, same or similar structural elements are assigned a same or similar reference numeral.

In the following description and in the drawings, an aligning direction in which a pair of terminals included in an energy storage device align, or a facing direction in which a pair of short side surfaces of a container of an energy storage device face each other is defined to be an X-axis direction. A facing direction in which a pair of long side surfaces of a container of an energy storage device face each other, or a thickness direction (flat direction) of an energy storage device or a spacer, or an aligning direction in which the energy storage devices and the spacers align, is defined to be a Y-axis direction. A protruding direction in which a terminal of an energy storage device protrudes, an aligning direction in which a container main body portion and a container lid portion of an energy storage device align, an aligning direction in which a case main body and a lid of a case align, a facing direction in which an opening and a bottom wall of a case main body face each other, an aligning direction in which an energy storage device (or a spacer), a bus bar holder, a bus bar cover, and a lid of a case align, or an up-down direction is defined to be a Z-axis direction. The X-axis direction, the Y-axis direction, and the Z-axis direction are directions intersecting each other (orthogonal to each other in the present example embodiment). Although there may be case where the Z-axis direction does not conform to the up-down direction depending on a use mode, the Z-axis direction will be described as the up-down direction in the following for convenience of description.

In the following description, for example, an X-axis positive direction indicates a direction of an arrow in the X-axis, and an X-axis negative direction indicates a direction opposite to the X-axis positive direction. When simply referred to as the X-axis direction, it indicates both or one of the X-axis positive direction and the X-axis negative direction. The same applies to the Y-axis direction and the Z-axis direction. Hereinafter, the Z-axis direction is also referred to as a first direction, the X-axis direction is also referred to as a second direction, and a direction intersecting with the first direction and the second direction (a direction inclined from the X-axis direction or from the Y-axis direction) is also referred to as a third direction. Expressions indicating relative directions or postures, such as parallel and orthogonal, include cases where the directions or postures are not parallel or orthogonal in a strict sense. Two directions being parallel to each other means not only that the two directions are completely parallel to each other, but also that the two directions are substantially parallel to each other, in other words, a difference by several percent or so, for example, is included in the scope. In the following description, when the expression “insulation” is used, “insulation” is intended as “electrical insulation”.

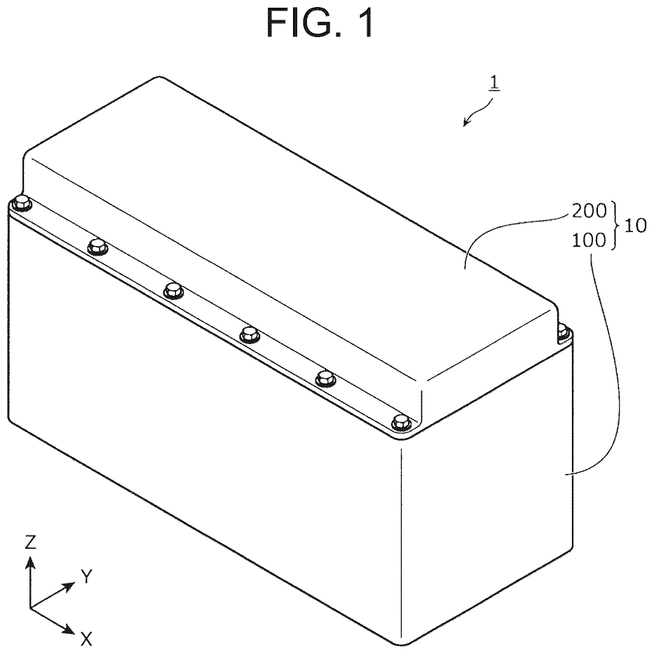

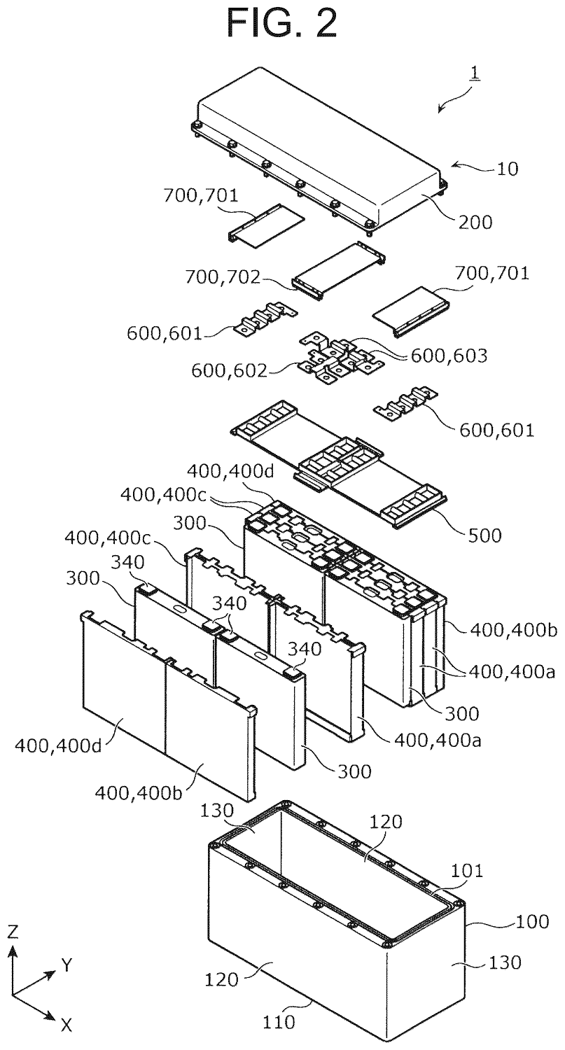

A schematic configuration of an energy storage apparatus 1 according to the present example embodiment will be described. FIG. 1 is a perspective view illustrating an outer appearance of an energy storage apparatus 1 according to the present example embodiment. FIG. 2 is an exploded perspective view illustrating respective structural elements when the energy storage apparatus 1 according to the present example embodiment is exploded.

The energy storage apparatus 1 is an apparatus which can be charged with electricity from outside and can discharge electricity to outside, and has a substantially rectangular parallelepiped shape in the present example embodiment. The energy storage apparatus 1 is, for example, a battery module (an assembled battery) used for an electric energy storage purpose or a power supply purpose. The energy storage apparatus 1 is used as, for example, a battery for driving or starting an engine of a movable body such as an automobile, a motorcycle, a watercraft, a vessel, a snowmobile, an agricultural machine, a construction machine, or a railway vehicle for electric railway. As the above-mentioned automobile, an electric vehicle (EV), a hybrid electric vehicle (HEV), a plug-in hybrid electric vehicle (PHEV), and a fossil fuel (gasoline, light oil, liquefied natural gas, or the like) automobile are exemplified. As the above-mentioned railway vehicle for electric railway, a train, a monorail, a linear induction motor train, and a hybrid train provided with both a diesel engine and an electric motor are exemplified. The energy storage apparatus 1 can also be used as a stationary battery, or the like, for home or business, etc.

As illustrated in FIG. 1, the energy storage apparatus 1 includes a case 10. As illustrated in FIG. 2, a plurality of energy storage devices 300, a plurality of spacers 400 (400a to 400d), a bus bar holder 500, a plurality of bus bars 600 (601 to 603), a plurality of bus bar covers 700 (701, 702), and the like, are accommodated inside the case 10. The energy storage apparatus 1 also includes an external terminal (positive electrode external terminal and negative electrode external terminal), or the like, for electrically coupling with an external apparatus, whose illustration and explanation are omitted. The energy storage apparatus 1 may include, in addition to the above-described structural elements, a restraint (an end plate, a side plate, or the like) that restrains the plurality of energy storage devices 300, a circuit board that monitors or controls a charge state, a discharge state, and the like, of the energy storage devices 300, electrical components such as a relay, a fuse, a shunt resistor, and a connector, an exhaust portion to exhaust gas discharged from the energy storage devices 300 to the outside of the case 10, and the like.

The case 10 is a container (module case) with a substantially rectangular parallelepiped shape (box shape), defining up an outer body (housing, outer shell) of the energy storage apparatus 1. The case 10 accommodates the plurality of energy storage devices 300, the plurality of spacers 400, and the like, fixes the plurality of energy storage devices 300, the plurality of spacers 400, and the like, in predetermined positions, and protects them from shocks, etc. The case 10 is a metal case including a metal, such as aluminum, an aluminum alloy, stainless steel, iron, or a plated steel plate, for example. In the present example embodiment, the case 10 may be formed by casting aluminum, specifically, by die casting (aluminum die casting). The case 10 may include a structural element including a material with insulating properties, such as any resin material that can be used for a spacer 400 to be described later.

As illustrated in FIG. 1, the case 10 includes a case main body 100 defining a main body of the case 10, and a lid 200 defining a lid of the case 10. The case main body 100 is a bottomed rectangular cylindrical housing (casing) including an opening 101 in the Z-axis positive direction, and accommodates therein the plurality of energy storage devices 300, the plurality of spacers 400, and the like. Specifically, the case main body 100 includes a bottom wall 110 having a flat-plate shape and a rectangular shape in the Z-axis negative direction, side walls 120 which are a pair of long side walls having a flat-plate shape and a rectangular shape on both sides in the Y-axis direction, and side walls 130 which are a pair of short side walls having a flat-plate shape and a rectangular shape on both sides in the X-axis direction. Depending on the configuration, or the like, of the case main body 100, the bottom wall 110 and the side walls 120 and 130 may have any shape, and the side wall 120 may be a short side wall and the side wall 130 may be a long side wall. The lid 200 has a flat rectangular shape which closes the rectangular opening 101 of the case main body 100. The case main body 100 and the lid 200 are joined to each other by screw fastening with bolts, or the like. Accordingly, the case 10 has a sealed (airtight) structure. The case main body 100 and the lid 200 may be joined to each other by welding, adhesion, or the like. The case main body 100 and the lid 200 may include structures made of a same material, or may include structures made of different materials. In the present example embodiment, the lid 200 is an example of a third member.

The energy storage device 300 is a secondary battery (a single battery) capable of charging electricity and discharging electricity, and more specifically, is a non-aqueous electrolyte secondary battery such as a lithium-ion secondary battery. The energy storage device 300 has a shape in which the length in the X-axis direction is longer than that in the Y-axis direction, specifically, a rectangular parallelepiped shape (square shape) which is flat in the Y-axis direction. In the present example embodiment, eight energy storage devices 300 are aligned in the X-axis direction and the Y-axis direction, for example. Specifically, two energy storage device arrays (two sets) each including four energy storage devices 300 aligned in the Y-axis direction are aligned in the X-axis direction. The size and shape of the energy storage device 300, the number of energy storage devices 300 to align, and the like, are not particularly limited, and the energy storage device 300 may have a long cylindrical shape, an elliptical cylindrical shape, a cylindrical shape, a polyhedral prism shape other than a rectangular parallelepiped shape, or the like, and only one energy storage device 300 may be provided. The energy storage device 300 is not limited to a non-aqueous electrolyte secondary battery, and may be a secondary battery other than a non-aqueous electrolyte secondary battery, or may be a capacitor. The energy storage device 300 does not have to be a secondary battery, and may be a primary battery from which electricity that is stored not by being charged can be used by the user. The energy storage device 300 may be a battery using a solid electrolyte. The energy storage device 300 may be a pouch-type energy storage device. A configuration of the energy storage device 300 will be described in detail below.

The spacers 400 (400a to 400d) are structures that are flat in the Y-axis direction, are aligned with the energy storage devices 300 in the Y-axis direction, and insulate and/or thermally insulate the energy storage devices 300 from other structures. The spacer 400 is an insulating plate or a thermally insulating plate adjacent to the energy storage device 300 in the Y-axis positive direction or the Y-axis negative direction of the energy storage device 300, and insulates and/or thermally insulates the energy storage devices 300 from each other or the energy storage device 300 from the case 10. For example, the spacer 400 is made of an insulating material, such as polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or ABS resin, or a combination thereof, or a material having thermal insulating properties, such as mica. The spacer 400 includes wall portions on both sides of the energy storage device 300 in the X-axis direction and both sides of the energy storage device 300 in the Z-axis direction, and functions as a holder to hold the energy storage device 300 and to position the energy storage device 300.

The spacer 400a is an intermediate spacer (intermediate holder) that holds two energy storage devices 300 on both sides of the spacer 400a in the Y-axis direction. The same applies to the spacer 400c. The spacer 400b is an end spacer (end holder) that holds one energy storage device 300 on one side of the spacer 400b in the Y-axis direction. The same applies to the spacer 400d. All of the spacers 400 (400a to 400d) may be made of a same material, or any of the spacers 400 may be made of a different material.

The bus bar holder 500 (also referred to as a bus bar frame or a bus bar plate) holds the bus bar 600, insulates the bus bar 600 from other structures, regulates the position of the bus bar 600, and the like. The bus bar holder 500 is a flat, substantially rectangular structure which is long in the X-axis direction, is positioned in the Z-axis positive direction of the plurality of energy storage devices 300 and the plurality of spacers 400, and is supported by the plurality of energy storage devices 300 and the plurality of spacers 400. Specifically, the plurality of bus bars 600 are positioned with respect to the bus bar holder 500, and the bus bar holder 500 is provided on the plurality of energy storage devices 300 and is positioned with respect to the plurality of energy storage devices 300. As a result, each bus bar 600 is positioned with respect to the plurality of energy storage devices 300, and is joined to the terminals 340 of the plurality of energy storage devices 300. For example, the bus bar holder 500 may include a material with insulating properties, such as any resin material adoptable to the above-described spacer 400.

In the present example embodiment, both end portions of the bus bar holder 500 in the X-axis direction have similar shapes, and both end portions of the bus bar holder 500 in the Y-axis direction also have similar shapes. That is, the bus bar holder 500 has a symmetrical shape in the X-axis direction and the Y-axis direction. Specifically, the bus bar holder 500 has a shape symmetrical with respect to a plane passing through a central position of the bus bar holder 500 and parallel to a YZ plane, and a shape symmetrical with respect to a plane passing through the central position and parallel to an XZ plane. Further, the bus bar holder 500 has a rotationally symmetric shape which has a similar shape even when rotated by 180° about a line passing through the central position of the bus bar holder 500 and parallel to the Z-axis. In the present example embodiment, the bus bar holder 500 is an example of a first member.

The bus bar 600 (601 to 603) are flat-plate shaped structures coupled to the energy storage devices 300. The bus bar 600 is located above the plurality of energy storage devices 300, and is coupled to the terminals 340 of the plurality of energy storage devices 300. Specifically, the bus bar 600 couples the terminals 340 of the plurality of energy storage devices 300 to each other, and electrically couples the terminal 340 of the energy storage device 300 at an end to an external terminal (not illustrated). In the present example embodiment, the five bus bars 600 couple each two energy storage devices 300 in parallel to configure four sets of energy storage device groups, and couple the four sets of energy storage device groups in series, for example. Specifically, among the five bus bars 600, the bus bar 601 in the X-axis positive direction couples two sets of energy storage device groups in the X-axis positive direction in series, and the bus bar 601 in the X-axis negative direction couples two sets of energy storage device groups in the X-axis negative direction in series. The bus bar 602 in a central portion in the X-axis direction and in the Y-axis negative direction couples two sets of energy storage device groups in the Y-axis negative direction in series. Two bus bars 603 in the central portion in the X-axis direction and in the Y-axis positive direction couple two sets of energy storage device groups in the Y-axis positive direction and a pair of (positive and negative) external terminals (not illustrated), respectively, via other bus bars, or the like.

The coupling configuration of the bus bar 600 is not particularly limited, and the plurality of energy storage devices 300 may be coupled in series in any combination, may be coupled in parallel, or all the energy storage devices 300 may be coupled in series or in parallel. The bus bar 600 and the terminal 340 are coupled (joined) to each other by welding, or the like, however, the coupling configuration therebetween is not particularly limited. The bus bar 600 includes a conductive material or metal such as aluminum, an aluminum alloy, copper, a copper alloy, or nickel, a combination thereof, a conductive material other than metal, or the like.

The bus bar cover 700 (701, 702) is positioned in the Z-axis positive direction of the bus bar 600 (601 to 603) and covers the Z-axis positive direction of the bus bar 600 (601 to 603). The bus bar cover 700 insulates the bus bar 600 from other structures (the lid 200, and the like). That is, the bus bar cover 700 and the bus bar holder 500 sandwich the bus bar 600, thus insulating the bus bar 600 from other structures. Specifically, the two bus bar covers 701 positioned at both end portions in the X-axis direction are respectively positioned in the Z-axis positive direction of the two bus bars 601, and cover the Z-axis positive direction of the respective bus bars 601. The bus bar cover 702 positioned at the central portion in the X-axis direction is located in the Z-axis positive direction of the bus bars 602 and 603, and covers the Z-axis positive direction of the bus bars 602 and 603.

In the present example embodiment, outer ends of the two bus bar covers 701 in the X-axis direction have similar shapes. That is, the two bus bar covers 701 have shapes which are symmetrical in the X-axis direction (symmetrical with respect to a plane parallel to the YZ plane), or shapes which are rotated by 180° with respect to each other about the Z-axis. Both end portions of the bus bar cover 702 in the Y-axis direction have similar shapes. That is, the bus bar cover 702 has a shape which is symmetrical in the Y-axis direction (a shape which is symmetrical with respect to a plane passing through the central position and parallel to the XZ plane), or a rotationally symmetrical shape which has similar shapes even when rotated by 180° about a line passing through the central position and parallel to the Z-axis. In the present example embodiment, the bus bar cover 700 (701, 702) is an example of a second member.

For example, the bus bar cover 700 includes a material having insulating properties, such as any resin material that can be used for the spacer 400 described above. In the present example embodiment, the rigidity of the bus bar cover 700 (second member) is lower than the rigidity of the bus bar holder 500 (first member) and the lid 200 (third member). As long as the magnitude relationship of rigidity is maintained, the bus bar holder 500 and the bus bar cover 700 may be made of a material obtained by blending a reinforcing material (a fibrous reinforcing material, a flat-plate shaped reinforcing material, or a granular reinforcing material) made of an inorganic substance or an organic substance into a resin material or the like, or a material whose rigidity is increased by applying the reinforcing material to a surface thereof, instead of the above-described resin material. Since the bus bar cover 700 includes such a resin material as described above, etc. and the lid 200 includes a metal material such as aluminum, the bus bar cover 700 is lower in rigidity than the lid 200. Here, when a same pressure is applied, a structure having a large deformation amount is defined to have “low rigidity”, and a structure having a small deformation amount is defined to have “high rigidity”. A configuration of the bus bar cover 700 will be described in detail below.

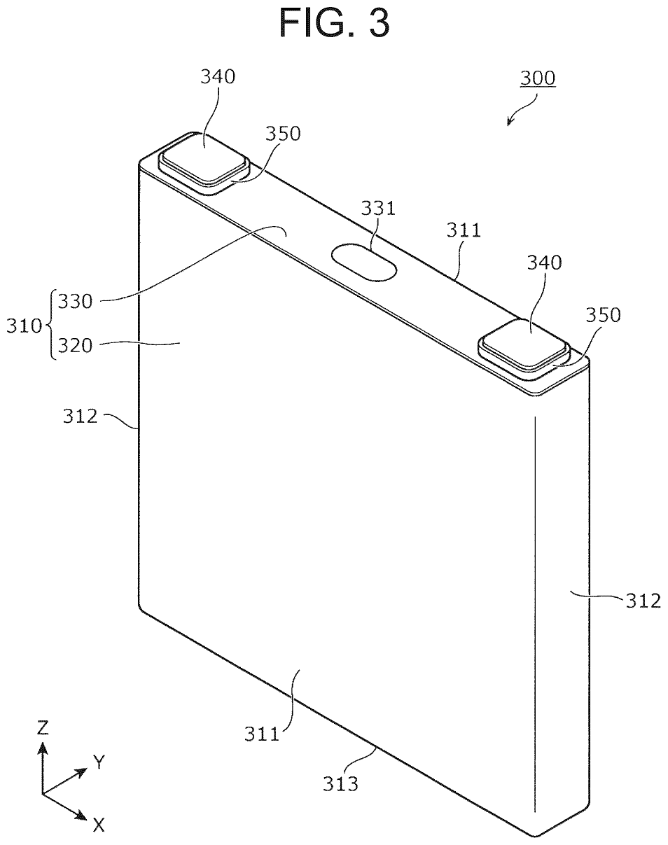

Next, a configuration of the energy storage device 300 will be described in detail. FIG. 3 is a perspective view illustrating a configuration of the energy storage device 300 according to the present example embodiment. FIG. 3 illustrates an enlarged view of the energy storage device 300 illustrated in FIG. 2. Since the plurality of energy storage devices 300 included in the energy storage apparatus 1 all have the same configuration, one energy storage device 300 is illustrated in FIG. 3, and the configuration of one energy storage device 300 will be described in detail below.

As illustrated in FIG. 3, the energy storage device 300 includes a device container 310, a pair of (positive and negative) terminals 340, and a pair of (positive and negative) gaskets 350. The device container 310 accommodates therein an electrode body, a pair of (positive and negative) current collectors, an electrolyte (non-aqueous electrolyte), and the like, which are not illustrated. This electrolyte may be of any type as long as it does not impair the performance of the energy storage device 300, and may be selected from various alternatives. The energy storage device 300 may include, aside from the above-described structural elements, a spacer to be located, for example, on the side of or underneath the electrode body, an insulating film to wrap around the electrode body, or the like, or an insulating film (e.g. shrink tube), etc. to cover an outer surface of the device container 310, and the like.

The device container 310 is a case having a rectangular parallelepiped shape (a square shape or a box shape), which includes a container main body portion 320 having an opening, and a container lid portion 330 closing the opening of the container main body portion 320. The container main body portion 320 has a rectangular cylindrical shape and includes a bottom, which defines a main body portion of the device container 310, and has an opening on the Z-axis positive direction side. The container lid portion 330 is a rectangular flat-plate shaped structure, which is long in the X-axis direction, defining a lid portion of the device container 310. The container lid portion 330 is positioned in the Z-axis positive direction of the container main body portion 320. The container lid portion 330 is provided with a gas exhaust valve 331 to release pressure in case the pressure increases excessively inside the device container 310, an injection portion (not illustrated), and the like, to inject an electrolyte inside the device container 310. The material of the device container 310 (the container main body portion 320 and the container lid portion 330) is not particularly limited. For example, while a weldable (joinable) metal such as stainless steel, aluminum, an aluminum alloy, iron, or a plated steel plate can be used, resin can also be used.

The device container 310 has a structure in which the inside thereof is sealed and airtight by joining the container main body portion 320 and the container lid portion 330 by welding, or the like, after an electrode body, or the like, is accommodated inside the container main body portion 320. The device container 310 includes a pair of long side surfaces 311 on side surfaces on both sides in the Y-axis direction, a pair of short side surfaces 312 on side surfaces on both sides in the X-axis direction, and a bottom surface 313 on the Z-axis negative direction side. The long side surface 311 is a rectangular planar portion that defines a long side surface of the device container 310, and is opposed to an adjacent spacer 400 in the Y-axis direction. The long side surface 311 is adjacent to the short side surfaces 312 and the bottom surface 313, and is larger than the short side surface 312. The short side surface 312 is a rectangular planar portion that defines a short side surface of the device container 310, and is opposed to a wall portion of the spacer 400 and the side wall 130 of the case 10 in the X-axis direction. The short side surface 312 is adjacent to the long side surfaces 311 and the bottom surface 313, and is smaller than the long side surface 311. The bottom surface 313 is a rectangular planar portion that defines a bottom surface of the device container 310, and is opposed to a wall portion of the spacer 400 and the bottom wall 110 of the case 10 in the Z-axis direction. The bottom surface 313 is adjacent to the long side surfaces 311 and the short side surfaces 312.

The terminals 340 are terminals (positive electrode terminal and negative electrode terminal) of the energy storage device 300, and are located on the container lid portion 330. Specifically, the terminals 340 protrude from an upper surface (terminal placement surface) of the container lid portion 330 towards the Z-axis positive direction. The terminals 340 are electrically coupled to a positive electrode plate and a negative electrode plate of the electrode body via the current collector. Namely, the terminal 340 is a metal structure to lead out electricity stored in the electrode body to an outer space of the energy storage device 300 and to introduce electricity into the internal space of the energy storage device 300 in order to store the electricity in the electrode body. The terminal 340 is made of aluminum, an aluminum alloy, copper, a copper alloy, or the like.

The electrode body is an energy storage (power generator) including a stack of a positive electrode plate, a negative electrode plate, and a separator. The positive electrode plate may be made by forming a positive electrode active material layer on a current collector foil made of metal such as aluminum or an aluminum alloy. The negative electrode plate may be made by forming a negative electrode active material layer on a current collector foil made of metal such as copper or a copper alloy. The active material used for the positive electrode active material layer and the negative electrode active material layer may be any known material as long as it can store and discharge lithium ions. As the separator, a microporous sheet, non-woven fabric, or the like, made of resin may be used. In the present example embodiment, the electrode body is formed by stacking polar plates (a positive electrode plate and a negative electrode plate) in the Y-axis direction. The electrode body may be any type of electrode body such as a wound electrode body formed by winding an electrode plate (a positive electrode plate and a negative electrode plate), a stacked-layer type (stack type) electrode body formed by stacking a plurality of flat-plate shaped electrode plates, or a bellows-type electrode body formed by folding an electrode plate in a bellows style.

The current collector is a conductive current collector member (positive electrode current collector and negative electrode current collector), which is either electrically coupled to the terminal 340 and the electrode body. The positive electrode current collector is formed of aluminum, an aluminum alloy, or the like, similarly to the current collector foil of the positive electrode plate of the electrode body, and the negative electrode current collector is formed of copper, a copper alloy, or the like, similarly to the current collector foil of the negative electrode plate of the electrode body. The gasket 350 is located between the container lid portion 330, and the terminal 340 and the current collector, and insulates between the container lid portion 330, and the terminal 340 and the current collector. The gasket 350 may be formed of any material as long as it has an insulating property.

A configuration of the bus bar cover 700 will be described in detail. In the present example embodiment, among the bus bar covers 700, the bus bar cover 701 in the X-axis negative direction has a configuration in which an end in the X-axis negative direction and a periphery thereof are the same as a configuration obtained by rotating, by 180°, a configuration of an end in the X-axis positive direction and a periphery thereof of the bus bar cover 701 in the X-axis positive direction. The bus bar cover 702 has a configuration in which both end portions in the Y-axis direction and a periphery thereof are the same as a configuration obtained by rotating, by 90°, a configuration of an end in the X-axis positive direction and a periphery thereof of the bus bar cover 701 in the X-axis positive direction. Therefore, hereinafter, configurations of the bus bar cover 701 in the X-axis positive direction and the periphery thereof will be described in detail, and descriptions of configurations of the bus bar cover 701 in the X-axis negative direction and the periphery thereof and configurations of the bus bar cover 702 and the periphery thereof will be omitted. Specifically, hereinafter, regarding the three members including the bus bar cover 701 (second member), the lid 200 (third member), and the bus bar holder 500 (first member) in the X-axis positive direction, a configuration of an end in the X-axis positive direction will be described, including a positional relationship thereof.

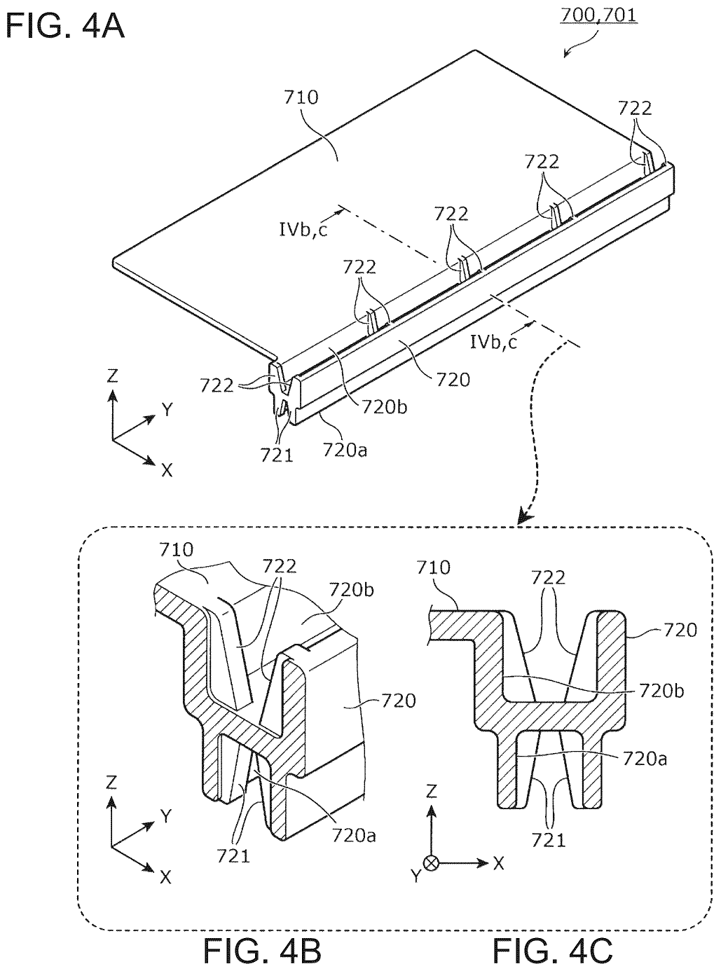

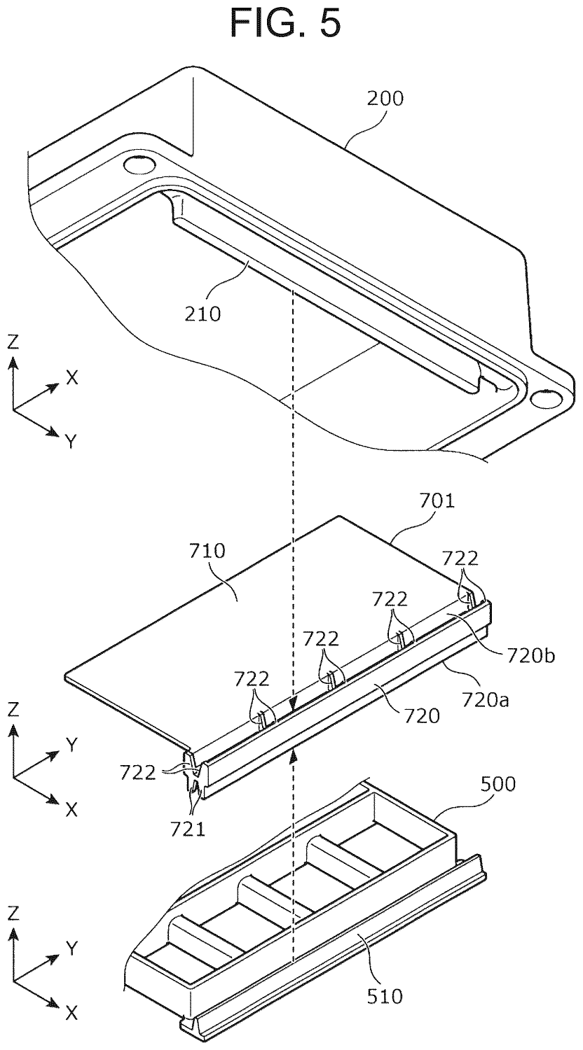

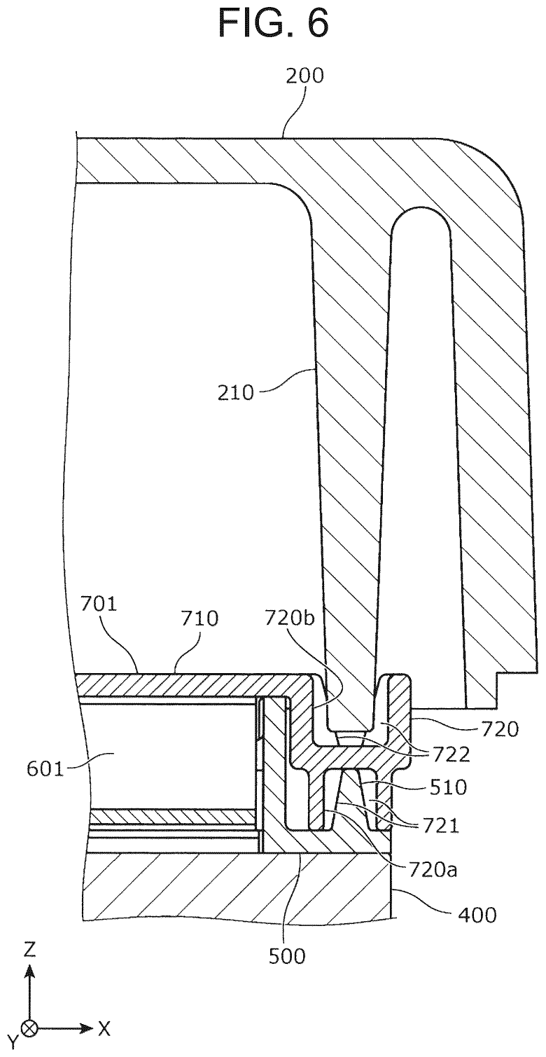

FIGS. 4A and 4B are a perspective view and a sectional view illustrating a configuration of a bus bar cover 701 according to the present example embodiment. Specifically, FIG. 4A is an enlarged perspective view illustrating a configuration of the bus bar cover 701 in the X-axis positive direction illustrated in FIG. 2. FIGS. 4B and 4C are views illustrating a cross section of the bus bar cover 701 illustrated in FIG. 4A, which is cut along a plane passing through line IVb, c-IVb, c and parallel to an XZ plane. FIG. 5 is a perspective view illustrating a positional relationship between the bus bar cover 701, the lid 200, and the bus bar holder 500 according to the present example embodiment. Specifically, FIG. 5 illustrates a configuration of an end of the lid 200 in the X-axis positive direction when viewed from below, and a configuration of an end of the bus bar cover 701 and the bus bar holder 500 in the X-axis positive direction when viewed from above. FIG. 6 is a sectional view illustrating a positional relationship between the bus bar cover 701, the lid 200, and the bus bar holder 500 according to the present example embodiment. Specifically, FIG. 6 illustrates a cross section when the bus bar cover 701, the lid 200, and the bus bar holder 500 are cut at the position shown in FIG. 4C.

As illustrated in FIG. 2, the bus bar cover 701 (second member) is between the bus bar holder 500 (first member) and the lid 200 (third member) above (i.e., in the Z-axis positive direction of) the energy storage device 300. That is, the bus bar holder 500 (first member), the bus bar cover 701 (second member), and the lid 200 (third member) are positioned in the Z-axis direction (first direction) of the energy storage device 300 and are aligned in the Z-axis direction (first direction).

As illustrated in FIGS. 4A to 4C to FIG. 6, the bus bar cover 701 includes a cover main body 710 and a cover end portion 720. The cover main body 710 is a flat plate-shaped and rectangular portion defining a main body portion of the bus bar cover 701, and is parallel to an XY plane. The cover main body 710 is positioned in the Z-axis positive direction of the bus bar 601 so as to sandwich the bus bar 601 between the cover main body 710 and the bus bar holder 500, and covers the Z-axis positive direction of the bus bar 601 (refer to FIG. 2 and FIG. 5).

The cover end portion 720 is a long portion that is located at an end of the cover main body 710 in the X-axis positive direction and extends in the Y-axis direction. In the present example embodiment, the cover end portion 720 protrudes in the Z-axis negative direction from an end of the cover main body 710 in the X-axis positive direction. A first groove portion 720a is located in a portion of the cover end portion 720 in the Z-axis negative direction, and a second groove portion 720b is located in a portion of the cover end portion 720 in the Z-axis positive direction. The first groove portion 720a is a rectangular recessed portion located in a portion of the cover end portion 720 in the Z-axis negative direction and is recessed in the Z-axis positive direction, and is a groove extending in the Y-axis direction from one end edge to an other end edge of the portion in the Y-axis direction. The second groove portion 720b is a rectangular recessed portion located in a portion of the cover end portion 720 in the Z-axis positive direction and is recessed in the Z-axis negative direction, and is a groove extending in the Y-axis direction from one end edge to an other end edge of the portion in the Y-axis direction. The first groove portion 720a and the second groove portion 720b overlap each other as viewed in the Z-axis direction. The sizes, shapes, and the like, of the first groove portion 720a and the second groove portion 720b are not particularly limited. However, in the present example embodiment, the second groove portion 720b is a larger groove (a groove in which a large recessed portion extends) than the first groove portion 720a.

The cover end portion 720 includes a first rib 721 in the first groove portion 720a, and a second rib 722 in the second groove portion 720b. The first rib 721 is a rib protruding in the X-axis direction from an inner surface of the first groove portion 720a in the X-axis direction. In the present example embodiment, two first ribs 721 protrude towards each other from two inner surfaces of the first groove portion 720a, which are opposed to each other in the X-axis direction. The two first ribs 721 are plate-shaped portions having a substantially triangular shape when viewed in the Y-axis direction, in which the thickness in the Y-axis direction is small and the width in the X-axis direction increases toward the Z-axis positive direction. Accordingly, a size (width) of a space between the two first ribs 721 in the X-axis direction decreases toward the Z-axis positive direction. In the first groove portion 720a, a plurality of sets (for example, five sets in the present example embodiment) of two first ribs 721 having such a configuration are aligned at a predetermined interval from one end edge to an other end edge in the Y-axis direction.

A holder protruding portion 510 provided at an end of the bus bar holder 500 in the X-axis positive direction is inserted into a space between each two first ribs 721 among the plurality of sets of first ribs 721. The holder protruding portion 510 is a long protruding portion which protrudes in the Z-axis positive direction from an end of the bus bar holder 500 in the X-axis positive direction and extends in the Y-axis direction from one end edge to an other end edge of the bus bar holder 500 in the Y-axis direction. The holder protruding portion 510 has a substantially triangular shape whose width in the X-axis direction decreases toward the Z-axis positive direction when viewed in the Y-axis direction, and is inserted between the two first ribs 721. The first rib 721 has a tapered shape in which a corner portion in the Z-axis negative direction has a curved shape and a surface in the X-axis direction is inclined relative to the Z-axis direction, and defines and functions as a guiding structure to guide the holder protruding portion 510 to a target location. In such a configuration, the two first ribs 721 are crushed by insertion of the holder protruding portions 510, such that surfaces thereof in the X-axis direction are in contact with the holder protruding portions 510 in the X-axis direction. Accordingly, the two first ribs 721 protrude in the X-axis direction towards the holder protruding portion 510, and sandwich the holder protruding portion 510 in the X-axis direction such that the bus bar cover 701 is attached (fixed) to the bus bar holder 500.

The second rib 722 is a rib protruding in the X-axis direction from an inner surface of the second groove portion 720b in the X-axis direction. In the present example embodiment, two second ribs 722 protrude toward each other from two inner surfaces of the second groove portion 720b, which are opposed to each other in the X-axis direction. Two second ribs 722 are plate-shaped portions having a substantially triangular shape when viewed in the Y-axis direction, in which the thickness in the Y-axis direction is small and the width in the X-axis direction increases toward the Z-axis negative direction. Accordingly, a size (width) of a space between the two second ribs 722 in the X-axis direction decreases toward the Z-axis negative direction. In the second groove portion 720b, a plurality of sets (for example, five sets in the present example embodiment) of two second ribs 722 having such a configuration are aligned at a predetermined interval from one end edge to an other end edge in the Y-axis direction.

A case protruding portion 210 provided at an end of the lid 200 in the X-axis positive direction is inserted into a space between each two second ribs 722 among the plurality of sets of second ribs 722. The case protruding portion 210 is a long protruding portion protruding in the Z-axis negative direction from an end of the lid 200 in the X-axis positive direction and extending in the Y-axis positive direction. The case protruding portion 210 has a substantially trapezoidal shape whose width in the X-axis direction gradually decreases towards the Z-axis negative direction when viewed in the Y-axis direction, and is inserted between the two second ribs 722. The second rib 722 has a tapered shape in which a corner portion in the Z-axis positive direction has a rounded shape and a surface in the X-axis direction is inclined with respect to the Z-axis direction, and has a guiding structure to guide the case protruding portion 210 to a target location. In such a configuration, the two second ribs 722 are crushed by insertion of the case protruding portion 210, such that surfaces thereof in the X-axis direction are in contact with the case protruding portion 210 in the X-axis direction. Accordingly, the two second ribs 722 protrude in the X-axis direction towards the case protruding portion 210, and sandwich the case protruding portion 210 in the X-axis direction such that the lid 200 is attached (fixed) to the bus bar cover 701.

In the present example embodiment, the second rib 722 has the same thickness in the Y-axis direction as that of the first rib 721, but has a larger width in the X-axis direction and a larger height in the Z-axis direction than those of the first rib 721. The second rib 722 is located at the same position as the first rib 721 in the Y-axis direction. The second ribs 722 are located slightly outside the first ribs 721 in the X-axis direction, but at least partially overlap the first ribs 721. That is, the second rib 722 overlaps at least partially with the first rib 721 in the X-axis direction and the Y-axis direction. Accordingly, the first rib 721 and the second rib 722 are located at positions overlapping each other when viewed from the Z-axis direction (first direction). The first rib 721 and the second rib 722 may be located at positions at which at least portions thereof overlap when viewed in the Z-axis direction. However, in the present example embodiment, the first rib 721 and the second rib 722a are located at positions at which a major portion (half or more) of the first rib 721 and about half of the second rib 722 overlap.

Similarly, the case protruding portion 210 of the lid 200 and the holder protruding portion 510 of the bus bar holder 500 are located at positions at which at least a portion thereof overlaps when viewed in the Z-axis direction. In the present example embodiment, the case protruding portion 210 and the holder protruding portion 510 are positioned to have the same central position in the X-axis direction. However, the case protruding portion 210 and the holder protruding portion 510 may be slightly shifted from each other. Furthermore, the first ribs 721 and the second ribs 722 are located at positions overlapping the energy storage devices 300 or the spacers 400 when viewed in the Z-axis direction. In the present example embodiment, the bus bar holder 500 is located on the spacer 400 at a position of the holder protruding portion 510, and is supported by the spacer 400 (refer to FIG. 6). Therefore, the first rib 721 and the second rib 722 are located at positions at which at least a portion thereof overlaps the spacer 400 when viewed in the Z-axis direction. Similarly, the case protruding portion 210 and the holder protruding portion 510 are located at positions at which at least a portion thereof overlaps the spacer 400 when viewed in the Z-axis direction. Accordingly, the case protruding portion 210, the second rib 722, the first rib 721, and the holder protruding portion 510 are supported by the spacer 400 in the Z-axis direction.

As described above, at least one of the bus bar holder 500 (first member) or the bus bar cover 701 (second member) includes the first rib 721 protruding towards the other in the X-axis direction (second direction intersecting with the first direction) and being in contact with the other in the X-axis direction (second direction). That one of the bus bar holder 500 (first member) and the bus bar cover 701 (second member) includes two first ribs 721 which sandwich the other in the X-axis direction (second direction). In the present example embodiment, the bus bar cover 701 (second member) includes two first ribs 721 which are in contact with the bus bar holder 500 (first member) in the X-axis direction (second direction) and sandwich the bus bar holder 500 (first member) in the X-axis direction (second direction). At least one of the bus bar cover 701 (second member) or the lid 200 (third member) includes a second protruding in the X-axis direction (second direction) towards the other and being in contact with the other in the X-axis direction (second direction). That one of the bus bar cover 701 (second member) and the lid 200 (third member) includes two second ribs 722 which sandwich the other in the X-axis direction (second direction). In the present example embodiment, the bus bar cover 701 (second member) includes two second ribs 722 which are in contact with the lid 200 (third member) in the X-axis direction (second direction) and sandwich the lid 200 (third member) in the X-axis direction (second direction).

As described above, in the energy storage apparatus 1 according to the present example embodiment, three members, i.e., the bus bar holder 500 (first member), the bus bar cover 700 (second member), and the lid 200 (third member), are aligned in the Z-axis direction (first direction), together with the energy storage devices 300. At least one of the bus bar holder 500 or the bus bar cover 701 (in the present example embodiment, the bus bar cover 701) includes a first rib 721 which is in contact with the other (in the present example embodiment, the bus bar holder 500) in the X-axis direction (second direction). At least one of the bus bar cover 701 or the lid 200 (in the present example embodiment, the bus bar cover 701): includes a second rib 722 which is in contact with the other (in the present example embodiment, the lid 200) in the X-axis direction. As described above, the bus bar holder 500 and the bus bar cover 701 are brought into contact with each other in the X-axis direction by the first ribs 721, such that a dimensional variation of the bus bar holder 500 and the bus bar cover 701 in the X-axis direction can be absorbed. The bus bar cover 701 and the lid 200 are brought into contact with each other in the X-axis direction by the second ribs 722, such that a dimensional variation between the bus bar cover 701 and the lid 200 in the X-axis direction can be absorbed. Accordingly, dimensional variations of the three members (the bus bar holder 500, the bus bar cover 701, and the lid 200) aligning together with the energy storage devices 300 can be absorbed with a simple configuration (without increasing the number of components), and therefore, the three members can be easily positioned.

In the bus bar holder 500 and the bus bar cover 701, two first ribs 721 of one of the mentioned members (in the present example embodiment, the bus bar cover 701) sandwich the other (in the present example embodiment, the bus bar holder 500) in the X-axis direction (second direction). Accordingly, dimensional variations of the bus bar holder 500 and the bus bar cover 701 on both sides in the X-axis direction can be absorbed.

Since the first rib 721 and the second rib 722 overlap each other when viewed from the Z-axis direction (first direction), a force can be applied to the vicinity of the first rib 721 and the second rib 722 by pushing the bus bar holder 500 and the lid 200 relative to the bus bar cover 701 at the overlapping positions from the Z-axis direction. Accordingly, the first rib 721 of one of the bus bar holder 500 and the bus bar cover 701 (the bus bar cover 701 in the present example embodiment) can be easily brought into contact with the other (the bus bar holder 500 in the present example embodiment). The second ribs 722 of one of the bus bar cover 701 and the lid 200 (in the present example embodiment, the bus bar cover 701) can easily contact the other (in the present example embodiment, the lid 200).

Since the bus bar cover 701 including the first rib 721 and the second rib 722 is lower in rigidity than the bus bar holder 500 and the lid 200, the first rib 721 and the second rib 722 are crushed when the first rib 721 and the second rib 722 contact the bus bar holder 500 and the lid 200. Accordingly, dimensional variations of the three members (the bus bar holder 500, the bus bar cover 701, and the lid 200) can be absorbed with a simple configuration.

The advantageous effects of the bus bar cover 701 in the X-axis positive direction has been described above. However, the same advantageous effects are achieved also regarding the bus bar cover 701 and the bus bar cover 702 in the X-axis negative direction.

So far, energy storage apparatuses according to certain example embodiments of the present invention have been described. However, the present invention is not limited to the above-described example embodiments. The example embodiments disclosed herein are illustrative in all aspects, and the scope of the present invention includes all example embodiments, and modifications and combinations thereof, within the meaning and scope of the claims and the doctrine of equivalents.

In the above-described example embodiments, the first member is the bus bar holder 500, the second member is the bus bar cover 700, and the third member is the lid 200 of the case 10. However, the first member and the third member may be any members as long as they can sandwich the bus bar cover 700. The first member may be the lid 200 of the case 10, and the third member may be the bus bar holder 500. The first member may be the case main body 100 of the case 10. The second member may be a member other than the bus bar cover 700. In this case, the first member, the second member, and the third member may be any members as long as they are aligned together with the energy storage device 300.

In the above-described example embodiments, the first rib 721 and the second rib 722 protrude in the same direction (second direction), but protrude in different directions. That is, the first rib 721 may protrude in the second direction, and the second rib 722 may protrude in the third direction. The third direction is a direction intersecting with the first direction and the second direction, and is a direction inclined from the X-axis direction, or is the Y-axis direction, in the above-described example embodiments. That is, at least one of the second member or the third member (the bus bar cover 701 (second member)) in the above-described example embodiments) may include the second rib 722 protruding in the third direction, toward the other (the lid 200 (third member) in the above-described example embodiments), and being in contact with the other in the third direction (two second ribs 722 sandwiching the other in the third direction). Accordingly, the second member and the third member (the bus bar cover 701 and the lid 200) are brought into contact with each other in the third direction by the second ribs 722, such that a dimensional variation between the second member and the third member in the third direction can be absorbed.

In the above-described example embodiments, the first rib 721 and the second rib 722 overlap each other when viewed from the first direction. However, the first rib 721 and the second rib 722 do not necessarily overlap each other when viewed from the first direction.

In the above-described example embodiments, in the bus bar cover 701, a plurality of sets of two first ribs 721 which are opposed to each other in the X-axis direction and have a substantially triangular shape when viewed from the Y-axis direction are aligned at a predetermined interval. However, the size, shape, position, number, and the like, of the first ribs 721 are not particularly limited. The first rib 721 may have any shape, such as a semicircular shape, a semi-elliptical shape, a semi-oval shape, or a polygonal shape other than a triangular shape, when viewed in the Y-axis direction. The first rib 721 may have a uniform thickness in the Y-axis direction, or may have a partially different thickness. All of the plurality of first ribs 721 may have a same thickness in the Y-axis direction, or any of the first ribs 721 may have a different thickness. At least one of the first rib 721 or the holder protruding portion 510 may have a structure to actively push the other in the X-axis direction or a structure to increase a frictional force between the first rib 721 and the holder protruding portion 510. The first ribs 721 may be positioned at any interval instead of a constant interval. The bus bar cover 701 may include only one set of two first ribs 721. A configuration is possible in which no other first rib 721 is provided at a position opposed to the first rib 721 in the X-axis direction. The same applies to the second rib 722. The bus bar cover 701 may include the cover end portions 720 (the first groove portion 720a and the second groove portion 720b) at any position of the cover main body 710. The same applies to the other bus bar covers 700.

In the above-described example embodiments, the second member (the bus bar cover 701) includes the first ribs 721 and the second ribs 722. However, the first member (the bus bar holder 500) may include the first ribs 721, and the third member (the lid 200) may include the second ribs 722. In this case, the second member (the bus bar cover 701) may include a protruding portion corresponding to the protruding portion (the holder protruding portion 510 or the case protruding portion 210) of the first member or the third member.

In the above-described example embodiments, a case in which the second member (the bus bar cover 701) is lower in rigidity than the first member and the third member (the bus bar holder 500 and the lid 200) has been illustrated. Any method may be used which can make the rigidity of the second member lower than the rigidity of the first member and the third member. For example, a method in which the outer shape of the second member is made to be lower in rigidity than the first member and the third member, a method in which the wall thickness of the second member is made to be thinner than the wall thicknesses of the first member and the third member, a method in which the second member includes a material softer than the first member and the third member, and the like, are exemplified. At least two methods may be combined.

In the above-described example embodiments, the second member (the bus bar cover 701) is lower in rigidity than the first member and the third member (the bus bar holder 500 and the lid 200), but may be higher in rigidity than at least one of the first member or the third member. When the second member is higher in rigidity than the first member, the first member may be crushed when the second member is attached to the first member. Also, when the second member is higher in rigidity than the third member, the third member may be crushed when the third member is attached to the second member.

In the above-described example embodiments, the first direction is set to be the Z-axis direction and the second direction is set to be the X-axis direction. However, the first direction and the second direction may be any directions as long as they are directions intersecting each other. The second direction may be a direction inclined from the X-axis direction, or may be the Y-axis direction. In the above-described example embodiments, in the bus bar cover 702, the first rib 721 and the second rib 722 protrude in the Y-axis direction, and thus the Y-axis direction is the second direction. The first direction may be a direction inclined from the Z-axis direction, or may be the X-axis direction or the Y-axis direction. That is, the first member, the second member, and the third member may be aligned in a direction inclined from the Z-axis direction, namely, the X-axis direction, the Y-axis direction, or the like.

In the above-described example embodiments, all of the bus bar covers 700 and the configurations around the bus bar covers 700 have the above-described configurations, but any of the bus bar covers 700 and the configurations around the bus bar covers 700 do not necessarily have the above-described configurations.

In the above-described example embodiments, as the bus bar covers 700, two bus bar covers 701 and one bus bar cover 702 are provided. However, the number of bus bar covers 700 is not particularly limited. A bus bar cover 700 different from those described above may be provided, or any of the above-described bus bar covers 700 does not necessarily have to be provided.

In the above-described example embodiments, as long as the case 10 includes the lid 200, the case 10 does not necessarily include the case main body 100. In the above-described example embodiments, the bus bar holder 500 is provided on the spacer 400 at the position of the holder protruding portion 510 and is supported by the spacer 400. However, the bus bar holder 500 may be supported by the energy storage device 300, may be supported by another other member, or does not necessarily have to be supported by any member. In the above-described example embodiments, the spacer 400 is a holder that holds the energy storage device 300, but does not necessarily hold the energy storage device 300.

Configurations constructed by combining elements, features, characteristics, etc., included in the above-described example embodiments and modification or combination examples thereof are also included in the scope of the present invention.

Example embodiments of the present invention can be applied to energy storage apparatuses, etc., each including an energy storage device such as a lithium-ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device; and
a first member, a second member, and a third member which are positioned in a first direction with respect to the energy storage device and are aligned in the first direction; wherein
the second member is between the first member and the third member;
at least one of the first member or the second member includes a first rib protruding towards the other of the first member or the second member in a second direction intersecting the first direction, the first rib being in contact with the other of the first member or the second member in the second direction; and
at least one of the second member or the third member includes a second rib protruding towards the other of the second member or the third member in the second direction or in a third direction intersecting the first direction and the second direction, the second rib being in contact with the other of the second member or the third member in the second direction or the third direction.

2. The energy storage apparatus according to claim 1, wherein
the at least one of the first member or the second member includes two first ribs, including the first rib, interposing the other of the first member or the second member in the second direction.

3. The energy storage apparatus according to claim 1, wherein
the first rib and the second rib overlap each other when viewed from the first direction.

4. The energy storage apparatus according to claim 1, wherein
the second member includes the first rib and the second rib, and rigidity of the second member is lower than rigidity of the first member and rigidity of the third member.

5. The energy storage apparatus according to claim 1, wherein
the first member is either a bus bar holder which holds a bus bar, or a case which accommodates the energy storage device.

6. The energy storage apparatus according to claim 2, wherein
the first rib and the second rib overlap each other when viewed from the first direction.

7. The energy storage apparatus according to claim 2, wherein
the second member includes the first rib and the second rib, and rigidity of the second member is lower than rigidity of the first member and rigidity of the third member.

8. The energy storage apparatus according to claim 2, wherein
the first member is either a bus bar holder which holds a bus bar, or a case which accommodates the energy storage device.

9. The energy storage apparatus according to claim 1, further comprising a plurality of energy storage devices including the energy storage device.

10. The energy storage apparatus according to claim 9, wherein the plurality of energy storage devices are arrayed to define two energy storage device arrays.

11. The energy storage apparatus according to claim 1, wherein the third member is a lid of a case containing the energy storage device.

12. The energy storage apparatus according to claim 1, wherein the energy storage device is a secondary battery.

13. The energy storage apparatus according to claim 1, wherein the energy storage device is a lithium-ion secondary battery.

14. The energy storage apparatus according to claim 1, further comprising:
two first ribs including the first rib;
a first protruding portion between the two first ribs;
two second ribs including the second rib; and
a second protruding portion between the two second ribs.

15. The energy storage apparatus according to claim 1, wherein
the first rib includes a plate-shaped portion with a substantially triangular shape and a width in the second direction that increases toward a positive side of the first direction, and the first rib has a tapered shape including a curved corner portion and an inclined surface; and
the second rib includes a plate-shaped portion with a substantially triangular shape and a width in the second direction that increases toward a negative side of the first direction, and the first rib has a tapered shape including a curved corner portion and an inclined surface.

16. The energy storage apparatus according to claim 1, wherein the second member is a bus bar cover.

17. The energy storage apparatus according to claim 1, wherein the first member is a bus bar holder, the second member is a bus bar cover, and the third member is a lid of a case.

18. The energy storage apparatus according to claim 17, wherein the bus bar cover is lower in rigidity than the lid.

19. The energy storage apparatus according to claim 1, wherein the first member is a bus bar holder or a lid of a case or a case main body of the case, the second member is a bus bar cover or a structure other than the bus bar cover, and the third member is the lid of the case or the bus bar holder.

20. The energy storage apparatus according to claim 1, wherein the second member is a bus bar cover, and the first member and the third member are any structure that interposes the bus bar cover.
